(19) United States
(12) Patent Application Publication
(10) Pub. No.: US 2019/0015740 A1
(43) Pub. Date: Jan. 17, 2019

(54) MOBILE GAMING AND PEER TO PEER GIFTING, RECEIVING AND DONATING PLATFORM USING BLOCK CHAIN INTEGRATION OF CENTRALIZED OR DECENTRALIZED PUBLIC LEDGERS FOR GAMING ELEMENTS TO FORM, ENCRYPT AND DISTRIBUTE DIGITAL OR CRYPTO CURRENCY AGAINST SERVER GENERATED GAMING

(71) Applicants: Jerry David Foley, Canyon Lake, CA (US); Kevin Edward Sprouse, St. Charles, MO (US); Douglas R. Elliott, Chesterfield, MO (US)

(72) Inventors: Jerry David Foley, Canyon Lake, CA (US); Kevin Edward Sprouse, St. Charles, MO (US); Douglas R. Elliott, Chesterfield, MO (US)

(21) Appl. No.: 16/125,739

(22) Filed: Sep. 9, 2018

Related U.S. Application Data
(60) Provisional application No. 62/531,157, filed on Jul. 11, 2017.

(51) Int. Cl. A63F 13/213; A63F 13/35; A63F 13/79

(52) U.S. Cl. CPC A63F 13/213; A63F 13/79; A63F 13/35

(57) ABSTRACT

The invention comprises methods, systems and processes for mobile/online software generated games and implemented through digital media devices. More specifically, this invention discloses methods, processes and systems for combining verified player inputs using an image scanning device feature to participate in a gaming method and process involving a plurality of algorithms. Using the unique online gaming systems with real time serial inputs, the invention enables players to receive, donate, gift or transfer electronic considerations or currencies measured and allocated by said unique online gaming systems with real time serial inputs. Further, the invention discloses the use of the game engine in block chain algorithms, systems and processes to create digital currency of definite value for gift, exchange, transfer or transaction purposes. Finally, the invention incorporates a quantum computing feature to hold an encrypted digital currency in suspense.

### TECHNICAL FIELD

This invention relates generally to online software generated games and digital media devices. More specifically, this invention disclosed novel methods and systems for combining verified player inputs using an image scanning device feature to participate in using printed U.S. currency serial numbers for gamification for peer to peer gifting using a plurality of algorithms.

Further, using the unique online gaming systems with real time serial inputs, the invention enables players to receive, donate or transfer electronic considerations or currencies measured and allocated by said unique online gaming systems with real time serial inputs.

Still further, the invention discloses a novel financial system, process and device relating to the block chain creation of encrypted digital currencies that utilize game elements and still further, user interactions with said game processes.

Still further, the invention discloses a method wherein a quantum computing device can operatively integrate with a game block chain to hold a retroactively determinable value that is determined by execution of the quantum computing element of the block chain upon occurrence of an event in real time or intentional activation of said quantum computing element.

### BACKGROUND OF THE PRESENT INVENTION

Online interactive gaming systems for gambling or recreational purposes encompasses known prior art for which there are existing products and services. The US and global marketplaces for such existing products and services are quite large. Currently these products generate over US $7 Billion in annual gross revenue. Not withstanding such a plurality of commercial products and services, current practices do not provide solutions within the prior art to simultaneously combine online gaming and real time charitable user needs into a useful product and service. Further, such prior online gaming systems do not provide a real time charitable conduit that can constitute a sustainable means for providing a source of revenues to individuals or organizations with capital to supply basic support and to succor and alleviate untreated suffering. Without limitation, such current charitable activities are referred to as: “Pay It Forward”, Gift, Share, Sharing, Virtual Community, Reciprocity, Peer to Peer social activities.

Online games are created for a broad range of electronic platforms, such as personal computers in a wide range of configurations, proprietary video game consoles, mobile game devices, mobile telephones, and the like. It is desirable that the disclosed invention is designed to anticipate operation and use across multiple device platforms. A novel requirement of the invention is a digital scanning capability to enter game content into the system to create user ID, game input and time-based record of activity.

Separately, block chain technology is a more recently known and systematic method using computers and software to create unique digital objects that may serve a variety of useful purposes. The term ‘block chain’ refers to the incorporation of portions of the computational steps of a first software based digital object that creates a unique computational successor identity of the referenced digital object. The computational process may be distributed and duplicated over a plurality of computational devices that can function as a public, non-managed creation and distribution system. In the alternative, block chain systems may be restricted on private networks, managed by third parties or restricted with respects to blockchain users.

At the time of this disclosure, the use of block chain networks to create secure and virtual digital currency is the most conspicuous and well-known use of the technology. ‘Bitcoin’ is the best known of these so-called ‘cryptocurrencies’. Block chain games are also known and used to ‘mine’ digital currency through player use of said games. The value of such digital currency mining is increased through the addition of computing steps to increase the complexity and computational processing of a finite number of original coin programs to their serial successor forms. The unique code of each successor iteration acts as an authentication of the digital cryptocurrency. Users may create so-called electronic wallets which are secure digital storage devices to hold addresses for later online access. Commercial exchange of the cryptocurrency units can obtain equivalence values of the cryptocurrency in other sovereign currencies or commodities like precious metals at future points in time.

Quantum computing is a recent emerging technology which involves device algorithms employing quantum mechanical state changes in discrete quantizable particles. Particle quantum states that are degenerative to more than one quantum state provide Feynman solutions which can hold multiple solutions in quantum time. With respects to block chain algorithms, such quantum computing elements provide unique block chain utility particularly where statistically variant outcomes are desired as in games of chance or change in value instruments involving risk in adverse outcomes.

Therefore, a multiple player online game accessing the internet and streaming media to provide for simultaneous charitable activity as a donor or recipient is desirable. What is sought is a useful and simple game system and games that maximizes the number of players and beneficiaries across the greatest possible number of platforms that connects players with donative or charitable activities in real time. It is therefore desirable to provide a gaming system and games that achieves the opportunities set forth here.

A still further utility of the current invention is to convert some or all the digital elements of the user and gaming elements into unique digital, encrypted objects of value via block chain processes, systems devices that integrate game activities as a principal element of the continuous production of the said digital objects of value.

Therefore, and without limitation, for users of the said gaming invention, these invention features provide;

a novel means system and process to provide game-based entertainment experiences that concurrently provide donative or charitable means, systems and processes to provide financial means to the less fortunate;

a means to provide such game-based entertainment and charitable activities to multiple users via wireless or independent computerized devices, including portable communication devices;

a means, system and process to store and cause a change in value to the value exchanging elements of the game;

a means, system and process to securely store such accumulated objects of value until otherwise deployed by the owner of such value;

a means, system and process to exchange the use of such gaming processes and outputs to internal or external block chain engines to encrypt and cause a change in value to such value exchanging elements of the game internal digital currencies or to external digital currencies;

a means, system and process to incorporate a quantum computing device to operatively integrate with a game block chain to hold a retroactively determinable value that is determined by execution of the quantum computing element of the block chain upon occurrence of an event in real time or intentional activation of said quantum computing element.

### Prior Art Search

A search of the literature and prior disclosures of published inventions identified certain elements from which this invention is distinguished. Such distinctions provide clarity of the novel and non-obvious features of the present to invention and further distinguished as follows.

Referring now to United States Patent Application 20170091725, AUCTION AND PAYMENT PROCESSING METHODS FOR POINTS OF CHARITY FUND RAISERS, the application ‘teaches a method of conducting an auction on behalf of a charity or other organization, including having bidders provide payment information at a check-in, and giving to each bidder a sticker sheet having thereon a machine scan able code associated with the bidder’. While the invention involves the electronic processing of auction payments, it does not anticipate a continuous game format for generating charitable proceeds or the combining of a plurality of charitable payments from diverse and otherwise anonymous game users. Further, the game proceeds are defined and certain for the play of the game and no price discovery is desired or sought in the present invention as an intended purpose of auctions.

Referring now to United States Patent Application 20170091726, LOW BANDWIDTH CRYPTO CURRENCY TRANSACTION EXECUTION AND SYNCHRONIZATION METHOD AND SYSTEM, the application claims, ‘A method for synchronizing a crypto-currency balance ledger stored on a device with data from the associated public crypto-currency block chain. The method comprises receiving from the public block chain data related to incoming transactions as limited to unspent transaction outputs (UTXOs), receiving from the public block chain data related to outgoing transactions that are conducted within a predetermined time frame as determined by a user, and determining whether the data received matches a current balance ledger as stored on the device; and if a match is not indicated updating the current balance ledger to generate an updated balance ledger’. The application deals with externally created crypto currencies from public block chains and validation methods to authenticate and update most recent public blockchain transactions within certain time frames. The present invention is not itself a public block chain but rather provides a private blockchain for its users and donees. Its external use is as a service utility to provide a block chain block that has a unique transaction signature based on the randomized use of game users which is neither anticipated or obvious by the prior disclosure.

Referring now to United States Patent Application 20170178237, COMPUTER IMPLEMENTED FRAMEWORKS AND METHODS CONFIGURED TO CREATE AND MANAGE A VIRTUAL CURRENCY, the application discloses ‘computer implemented frameworks and methods configured to create and manage a virtual currency bearing characteristics of both a cryptocurrency and fiat money at the same time.’ This application acts a kind of virtual ATM providing a mixture of crypto and fiat currencies whose exchange transactions act as validation and authentication block chain mechanisms. However, the disclosure does not anticipate the intentional use of a online gaming system to define its transactional network and whose purposeful design relies on risk based outcomes.

Referring now collectively to United States Patent Applications 20170228734, SYSTEM FOR SECURE ROUTING OF DATA TO VARIOUS NETWORKS FROM A PROCESS DATA NETWORK, United States Patent Application 20170132630, BLOCK CHAIN ALIAS FOR PERSON-TO-PERSON PAYMENTS, and United States Patent Application 20170244757, SYSTEM FOR EXTERNAL VALIDATION OF SECURE PROCESS TRANSACTIONS, such transaction provide useful but unrelated validation applications for secure information, management, distribution and control. The restrictive access enabled by block chain algorithms intend to separate digital records from anonymous parties where the present disclosure invites secure aggregation of of user data.

No relevant prior art was discovered on the novel use of quantum computing within block chain networks or for risk based digital objects of conditional value.

### SUMMARY OF THE INVENTION

What is disclosed is an online gaming system and representative game which overcomes at least one of the problems, shortcomings or disadvantages set forth previously. In a preferred embodiment of the invention, the game system utilizes a physical object with a scan-able image that can be recorded in a device scanner by a particular player and where such class of physical object represents a plurality of similar objects whose scanned image can be ordered into countable sets of sequenced images by a plurality of players. Printed currency or objects containing a serially generated sequential identifier marks are preferred objects for players to access. The information of the scanned image of a similar object class is entered into an online accessible secure server or decentralized public ledger through a user specific account with a time stamp to then access an online gaming engine for serial gameplay. In a further preferred embodiment, the invention comprises a unique game referred hereafter as DollarZing/CryptoZing (or collectively referred to as *Zing) that, without limitation, discloses the essential invention elements and novelties. Concurrently, and either coordinate with the active game users of *Zing, or autonomously as through autonomous gameplay, the present invention functions as a block chain applied currency algorithm whose invention elements will be described later in this application. Stepwise and with respects only to the active game use of DollarZing/CryptoZing, a preferred embodiment of the invention occurs as follows:
1. The game user snaps a picture of any US $ Bill
2. The DollarZing App of the gameuser's mobile device reads the user's respective exclusive 8-digit serial number on the US $ Bill.
3. The DollarZing App identifies the serial number into a real time specific game element in the server or decentralized public ledger gameware of the hosted website for the user account.
4. The user Serial number is multiplied, divided, added and subtracted using a proprietary algorithm to determine and rank highest value of the serial number to the lowest value of the serial numbers.
5. Progressive game play at a specific time or quantity of community members $ bills below 50% play of the ranked serial numbers each other and game user and $ bills 50% and above the ranked serial numbers play each other.
6. All DollarZing community members agree to have a 50/50 opportunity to receive the total amount of “Pay It Forward” ZingCash from the member.
7. The user decides to play the amount received or snap another $ bill.
8. $ US bills are used to play a Fiat Money, Virtual Currency and Crypto Currency gift sharing game.
9. DollarZing uses $ US bills to share with the virtual DollarZing community.
10. Serial number is calculated using a proprietary algorithm.
11. Player can share up to $10 per day and receive up to $10,000 per month. Virtual and Crypto Currency may differ
12. The player decides when to share or snap another $ bill.
13. The DollarZing community website/App will collect a specified user fee per DollarZingCash shared and charitable organizations will receive the same denomination or 10% after the community member receives their ZingCash from the daily tournament.
14. $1 can be played a maximum of 10 times per day doubling each time for a total potential tournament shared ZingCash of $1,024.00 less 10% for charitable causes.
15. The proprietary algorithm changes every day at 12:00:01p.m. E.S.T. USA to start a new tournament.

The invention thus provides a novel, device enabled system, process and method to link a community of game users to accomplish a charitable activity—accumulate and disburse charitable donations amongst the community or to designated beneficiaries to a separate community in need of such donative charity activity. The invention thereby creates a useful utility for undertaking charitable enterprise and community members.

Now and with respect to the preferred embodiment of the afore described game invention elements, the blockchain algorithm functions inter-operatively with the game elements as follows:
1. The game user snaps a picture of any US $ Bill
2. The DollarZing App of the gameuser's mobile device reads the user's respective exclusive 8-digit serial number on the US $ Bill.
3. The DollarZing App identifies the serial number into a real time specific game element in the server or decentralized public ledger gameware of the hosted website for the user account. At step 3 the server element defines a computational block chain algorithm based on the unique gameuser and recomputed each time the gameuser logs into the game. Offline of the DollarZing game itself, accessing of the gameuser can recompile the code to a different blockchain algorithm composed of a plurality of gameuser logins.
4. The user Serial number is multiplied, divided, added and subtracted using a proprietary algorithm to determine and rank highest value of the serial number to the lowest value of the serial numbers. At Step 4 the algorithm itself or the output of the algorithm can be recompiled into a blockchain algorithm of the gameuser blockchain. Offline to the DollarZing game itself the accessing of the step 4 algorithm can be recompiled to a different blockchain algorithm composed of a plurality gameuser serial number computations.
5. Progressive game play at a specific time or quantity of community members $ bills below 50% play of the ranked serial numbers each other and game user and $ bills 50% and above the ranked serial numbers play each other. At Step 5, a block chain algorithm can be used to recompile the play of each pool. Also at Step 5, in a preferred embodiment, a quantum computer element can process both ranked pools to apportion the blockchain sub-pool blocks into an element held in suspense prior to computing outcomes based upon a condition concurrent, precedent or subsequent to the pool play.
6. All DollarZing community members agree to have a 50/50 opportunity to receive the total amount of “Pay It Forward” ZingCash from the member.
7. The user decides to play the amount received or snap another $ bill. At Step 7, the blockchain process first identified at Step 3 are re-iterated in the steps 8 through 11 which follow.
8. $ US bills are used to play a Fiat Money, Virtual Currency and Crypto Currency gift sharing game.
9. DollarZing uses $ US bills to share with the virtual DollarZing community.
10. Serial number is calculated using a proprietary algorithm. See blockchain explanation at Step 4.
11. Player can share up to $10 per day and receive up to $10,000 per month. Virtual and Crypto Currency may differ. At Step 11 the blockchain re-iteration has a terminal event conditioned on the outcomes of prior gameplays and results of gameplays over the time interval.
12. The player decides when to share or snap another $ bill subject to conditions of Step 11 supra.
13. The DollarZing community website/App will collect a specified user transaction fee per DollarZingCash shared and charitable organizations will receive the same denomination or 10% after the community member receives their ZingCash from the daily tournament. At Step 13, charitable organizations or other external participants can enable separate block chain algorithms creating unique blocks for accumulating, disbursing or negotiating digitally created or stored elements of values.
14. $1 can be played a maximum of 10 times per day doubling each time for a total potential tournament shared ZingCash of $1,024.00 less 10% for charitable causes. See blockchain explanation at Step 11.
15. The proprietary algorithm changes every day at 12:00:01p.m. E.S.T. USA to start a new tournament. At Step 15, a blockchain algorithm recompiles the gameuser blockchain and or external blockchain code. A preferred embodiment of the blockchain at step 15 may employ a quantum computing element to hold such code recompilations in suspense as previously described and analogous to Step 5.
16. Thus, invention also provides a novel, device enabled system, process and method to link a game system to a block chain method, process and system which has a plurality of internal and external applications.

### BRIEF DESCRIPTION OF THE DRAWINGS

FIG. 1 “Overview of Invention for Player User” is a representation of the gameplay of DollarZing from a participant-user viewpoint as set forth in [0006] of the present disclosure;

FIG. 2 “Overview of Process for Donee Beneficiary of the Invention” illustrates the interconnection of game session parties, partners, players and charitable donee beneficiaries participating through DollarZing according to the present invention;

FIG. 3 “Overview of Invention Online credit and Exchange Process” illustrates the online account and disbursement of funds elements of the preferred invention;

FIG. 4 “Overview of Invention Process Security Elements” illustrates features of the present invention intended to prevent cheating or maintain security and financial integrity during competitive play and over the duration of the community member participations in the novel system.

FIG. 5 “Process Overview Incorporating Real Objects to Game Format” illustrates a flow diagram for implementation for an example DollarZing game application according to the present invention; and

FIG. 6 “Invention flowchart for gaming App” illustrates the sequential game App and decision trees of the preferred embodiment invention, DollarZing.

FIG. 7 “Overview of Invention for Player User with Block Chain integration” is a representation of the gameplay of DollarZing from a block chain viewpoint as set forth in [0006] of the present disclosure;

FIG. 8 “Overview of Process for Donee Beneficiary of the Invention with Block Chain integration” illustrates the interconnection of game session parties, partners, players and charitable donee beneficiaries participating through DollarZing to a Block Chain integration of the present invention;

FIG. 9 “Overview of Invention Online credit and Exchange Process with Block Chain integration” illustrates the online account and disbursement of funds elements of the preferred invention that are integrated into the Block chain elements;

FIG. 10 “Overview of Invention Process Security Elements with Block Chain integration” illustrates features of the present invention intended to prevent cheating or maintain security and financial integrity during competitive play and over the duration of the community member participations in the novel system that utilize or incorporate Block Chain elements.

FIG. 11 “Process Overview Incorporating Real Objects to Game Format with Block Chain integration” illustrates a flow diagram for implementation of an example DollarZing game application according to the present invention with Block Chain integration; and

FIG. 12 “Invention flowchart for gaming App with Block Chain integration” illustrates the sequential game App and decision trees of the preferred embodiment invention, DollarZing with Block Chain integration.

### DETAILED DESCRIPTION OF THE INVENTION

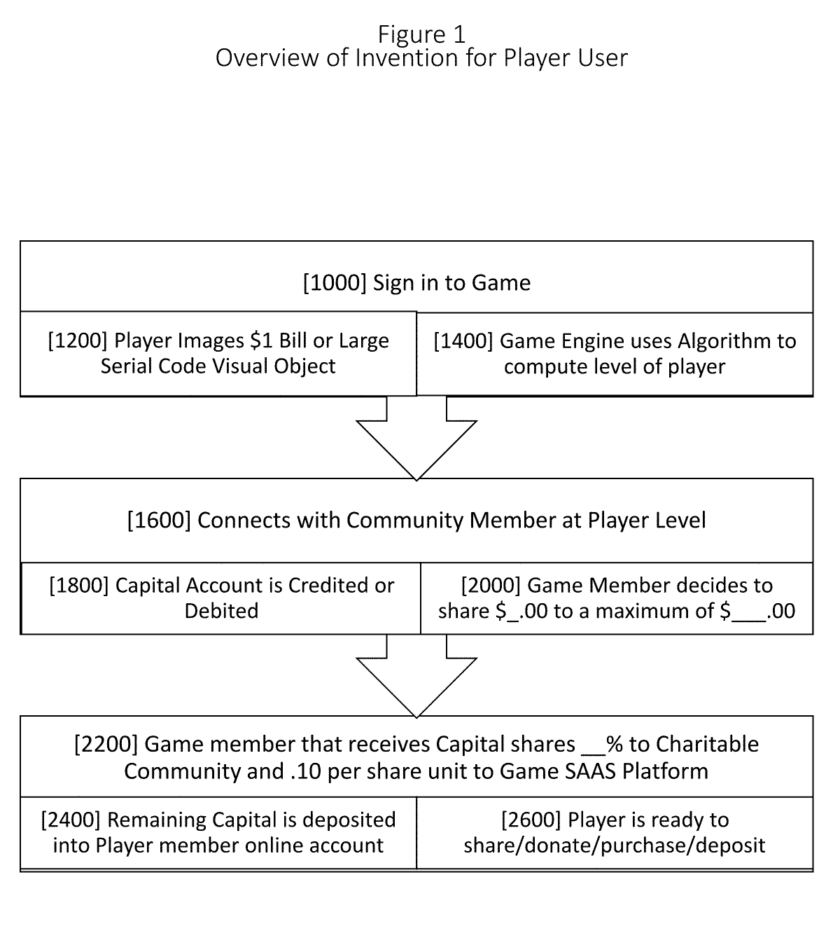

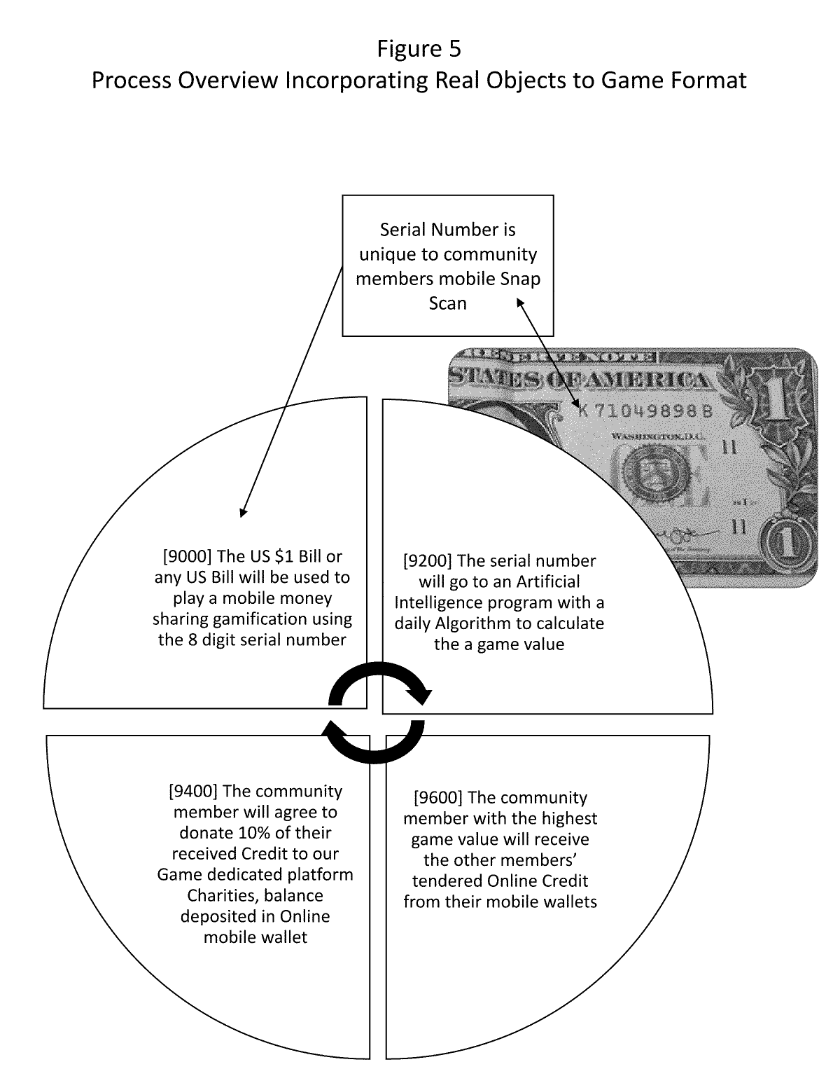

Referring now to the drawings, FIG. 1 is a top-level representation of a game system illustrating a multiple player, multiple gaming system platform for a gaming system according to the present invention. At [1000] a player employs a transmitting electronic device to enter into a unique online account registered to the host game application. Typically, the device will be a mobile telephonic or computer device also comprising a digital camera function. At [1200] a player of the disclosed invention will create an image of a pre-determined physical object such as a dollar bill that must contain a unique serial code or serial image where said image must contain said serial code or image. At [1400] the captured image is uploaded and transmitted to a host server containing the game engine which comprised in part an algorithm that computes a ranking based on the input serial number. This image capture scheme of this preferred embodiment is further disclosed in FIG. 5 in the iterative process steps of [9000] through [9600].

Therefore, gaming system of the present invention connects players for an effective game sharing experience across dramatically different gaming platforms for which FIG. 1 is a preferred embodiment.

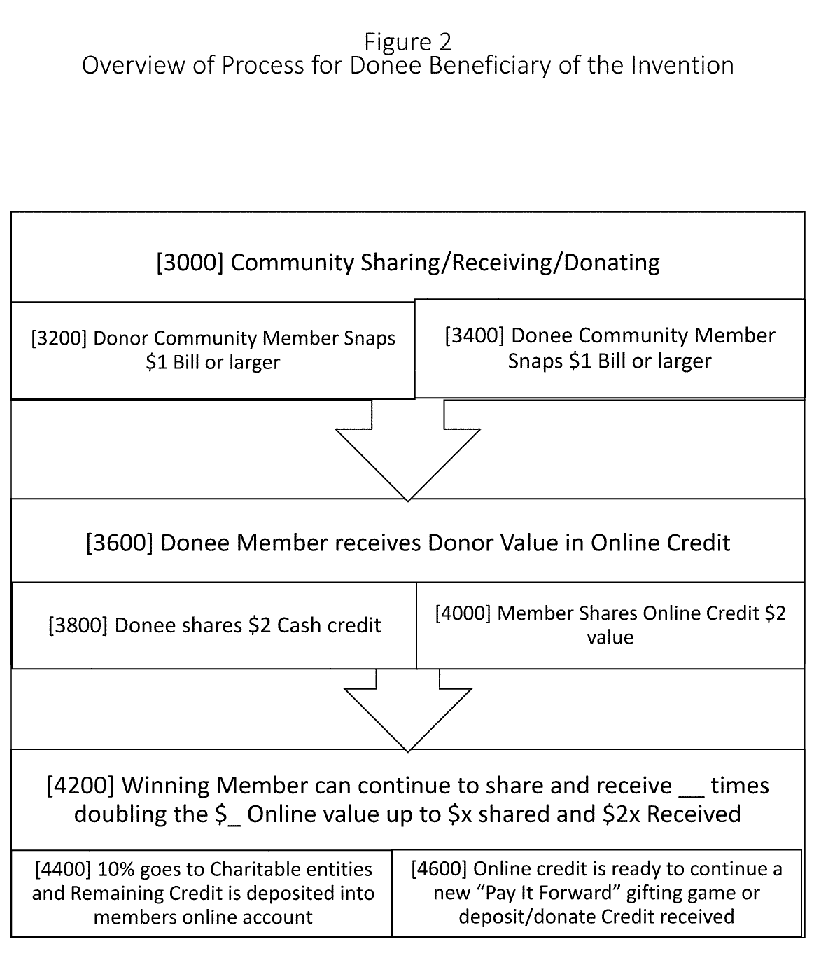

Referring now to FIG. 2, a preferred overview embodiment illustrates how a donee beneficiary realizes such donee proceeds. At [3000] the donative function commences based upon gameplay by co-participating members of the community. At [3200] the donor community member provides the unique serial code that is applied in the gameplay as described in FIG. 1. The donor member is deemed to be the community member whose account is debited to the credit benefit of the donee community member shown at [3400]. At steps [3600] to [4000] the game host server performs the online computer processes to allocate the digital funds from and among the respective online accounts. At [4200] through [4600] a winning community member (as donee) can iterate the gameplay and if such winning continues can accumulate successive done proceeds for account allocation as communicated in real time by the successful done.

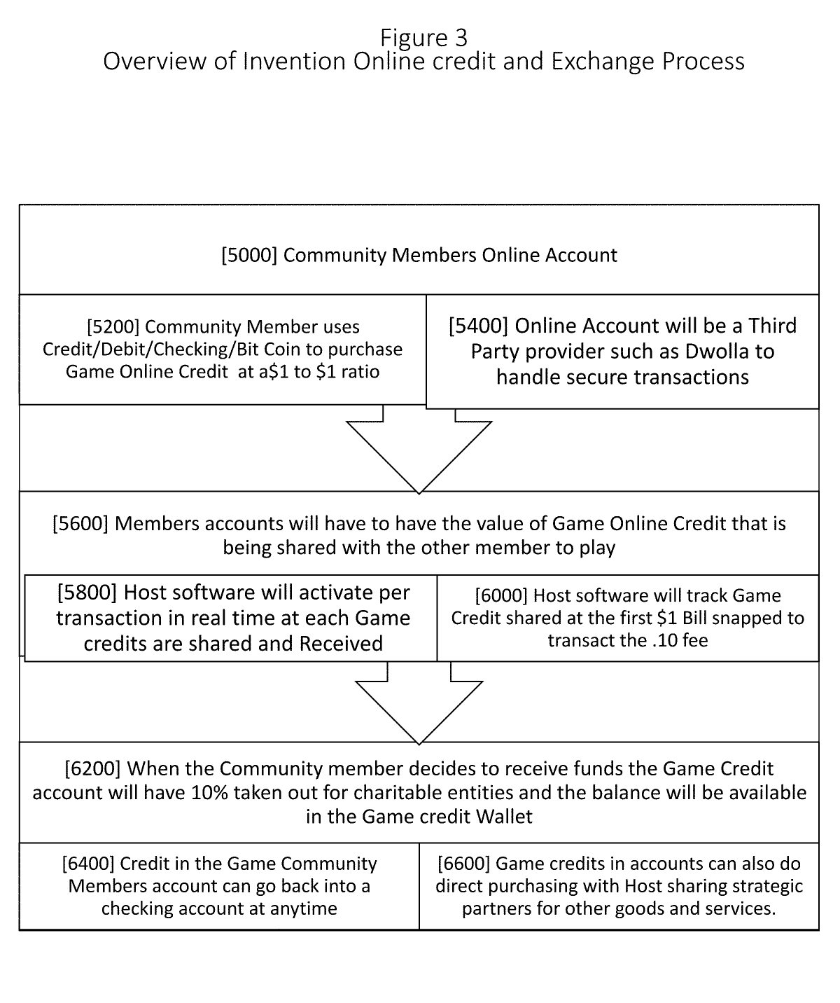

FIG. 3 figure depicts an overview of the invention's online credit and exchange process. At [5000] of FIG. 3, the description of the community member's online account is disclosed. At [5200] community members identify a non-game source of capital from conventional credit cards, banking or debit cards, or non-conventional capital such as Bit Coin (Crypto Currency from which to source game credits typically on a 1:1 exchange rate ratio. In the preferred embodiment at [5400] the maintenance of the plurality of online accounts will be through a third-party provider such as Dwolla to handle secure transactions.

Referring further to FIG. 3, at [5600] a queuing system will verify that all community members at time of gameplay have accounts sufficiently funded to cover all game obligations. At [5800] Host software will activate per transaction in real time at each Game credits are shared and Received. At [6000], Host software will track Game Credit shared at the first $1 Bill snapped to transact the 0.10 fee for the SAAS fee of the Host provider.

At [6200], where the gaming application has an expressed charitable service, then when the Community member decides to receive funds, the Game Credit account will have a sum certain, such as 10% taken out for charitable entities and the balance will be available in the Game credit Wallet. In a preferred embodiment at [6400], Credit in the Game Community Members account can go back into a checking account at any time. In a further preferred embodiment at [6600], Game credits in accounts can also do direct purchasing with Host sharing strategic partners for other goods and services.

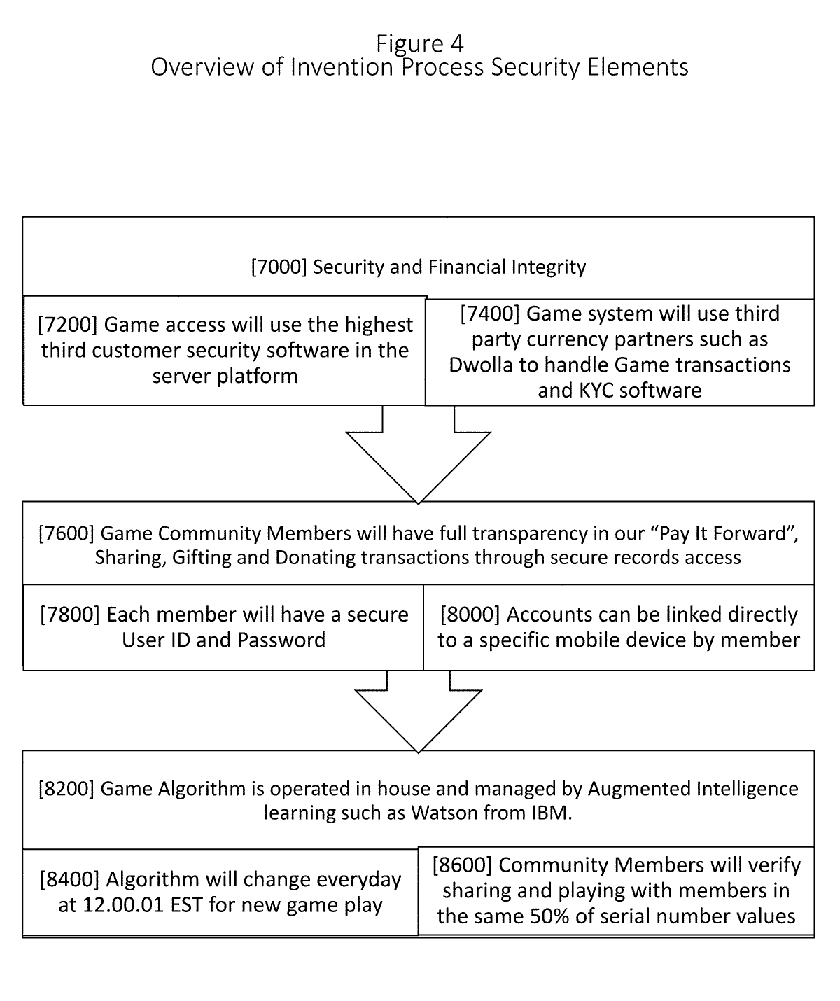

Referring now to FIG. 4 the overview of the invention security and financial elements is shown. At [7000] the security involves independent elements to protect, respectively the integrity of the security of the host server platform [7200] and the financial transaction partners [7400].

At [7400] Game Community Members will have full transparency in the “Pay It Forward”, Sharing, Gifting and Donating transactions through secure records using dedicated servers and Blockchain, DeCentralized Public Ledgers platforms such as Hedera Hashgraph. For the highest security possible. Each community member will have unique and secure User ID and Password protections. Further, at [8000] such secure links can be directly and exclusively linked to specific devices to avoid hacking or re-directed unauthorized entry attempts. Further security will be realized through game algorithms changed frequently [8400] and augmented by third party AI systems [8200]. Finally, [8600] Community Members will verify sharing and playing with members in the same 50% of serial number values at a pre-determined amount of players.

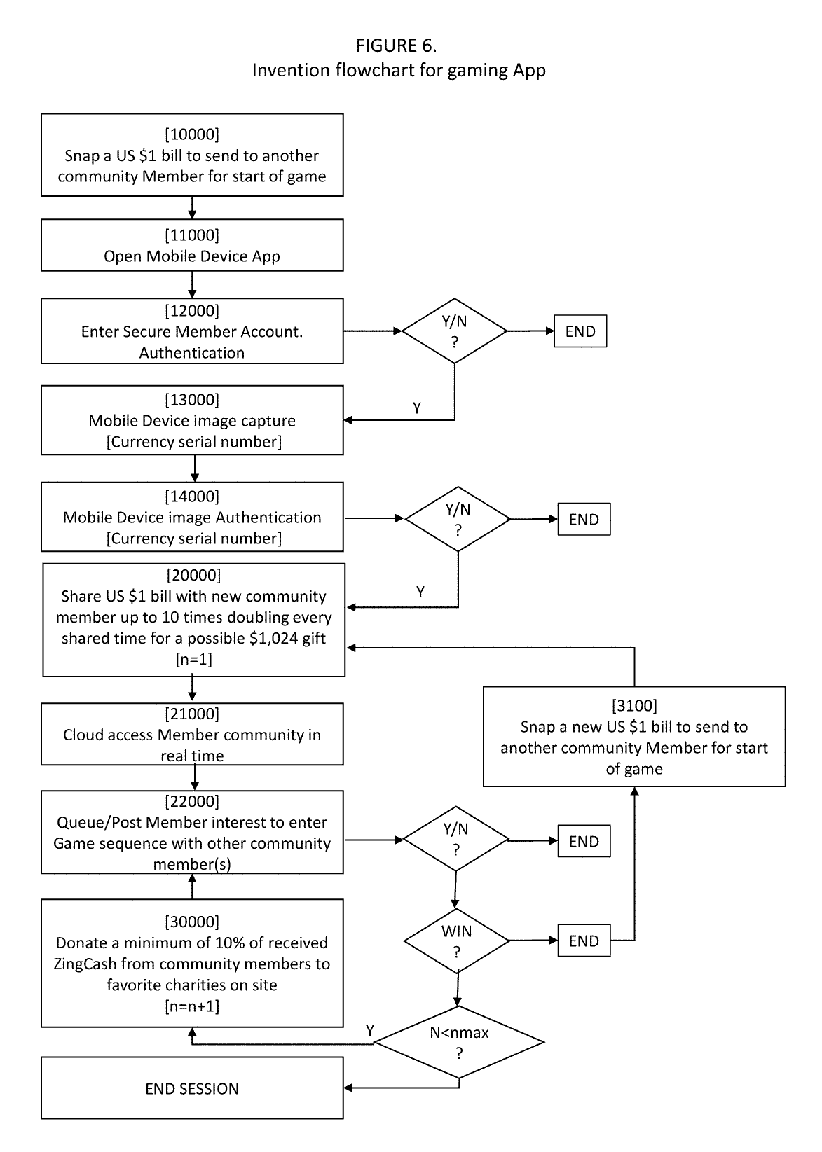

Referring now to FIG. 6, a comprehensive flowchart illustrates a preferred embodiment of the invention components in sequence that illustrates the function, software and decision tree elements used in sequence from a player mobile device and communicated to and from a host servers in communication with other users in real time. At [10000] the user snaps a US $1 bill to send to another community Member for start of game. The purpose is to capture a specific serial number. At [11000] the user opens the Mobile Device App. Next, at [12000] Enter Secure Member Account Authentication. A first decision tree verifies with an authentication algorithm. If unverified, the session terminates. If verified at [13000] the Mobile Device image capture comprising the Currency serial number, is entered into the game app for secure transmission to the remote host servers. At [14000] the Mobile Device Image Authentication [Currency serial number] is verified by the host servers to as valid within the game guidelines and not counterfeit or duplicate. A second decision tree verifies with a second authentication algorithm. If unverified, the session terminates. At [20000] the host queues a Share US $1 bill with new community member up to 10 times doubling every shared time for a possible $1,024 gift [n=1]. It also sets a count of the session iterations to terminate play at a specified count (nmax). At [21000] Cloud access another Member of the community in real time to play with initial member. This is accomplished at [22000]. If no member responds in a timely fashion, the session terminates at a third decision tree algorithm. A fourth decision tree determines the game outcome after converting the participant players serial number into ranking through the game algorithm. The winner of the game then proceeds to a count verification to determine if game play can be continued on an available iteration count. At [30000] the winner donate a minimum of 10% of received ZingCash from community members to favorite charities on site and the game count is set to (n=n+1). At [31000] a member may Snap a new US $1 bill to send to another community Member for start of a new game at [20000] Thereafter the session ends.

Other features of the invention intended to prevent cheating, particularly desirable in situations such as high stakes tournament play, are also included in the game application. As applied to DollarZing, prevention of cheating by collaboration of players to maximize the odds of winning is accomplished through random session assignment at certain levels of play. As illustrated by an example shown in FIG. 5, the conversion of physical serial codes cycles through an iterative cycle but limited by cycle to the selected serial codes of the participating members at [9000] through [9400]. Additional features of the game application are available and understood by example in relation to the DollarZing game application by one skilled in the art.

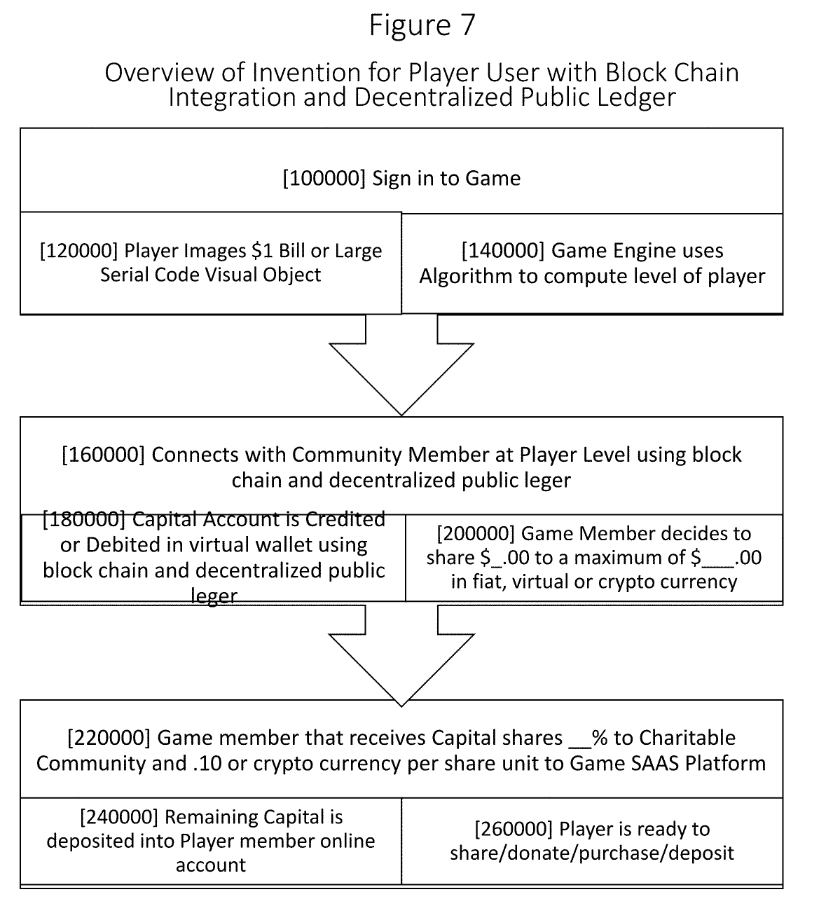

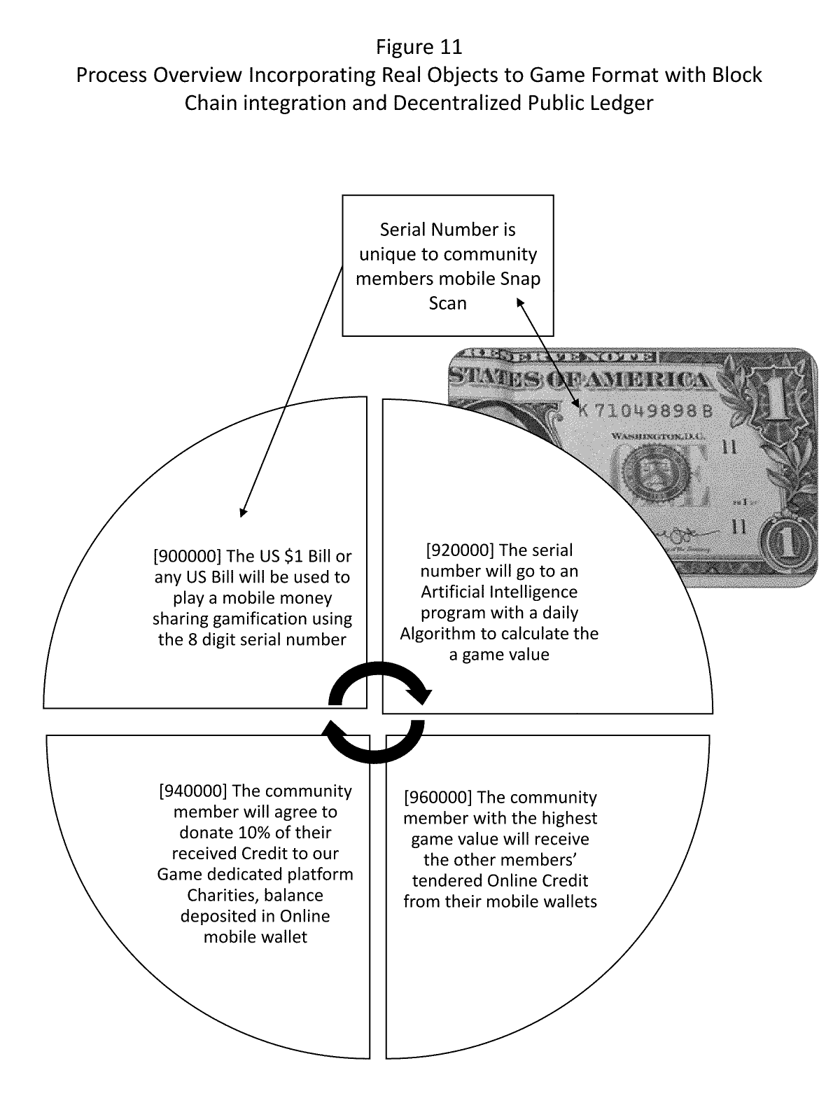

Referring now to the drawings, FIG. 7 is a top-level representation of the game system block chain illustrating a multiple player, multiple gaming system platform that generates a blockchain according to the present invention. At [100000] a player employs a transmitting electronic device to enter into a unique online account registered to the host game application. Typically, the device will be a mobile telephonic or computer device also comprising a digital camera function. At [120000] a player of the disclosed invention will create an image of a pre-determined physical object such as a dollar bill that must contain a unique serial code or serial image where said image must contain said serial code or image. At [140000] the captured image is uploaded and transmitted to a host server containing the game engine which comprises in part an algorithm that computes a ranking based on the input serial number. The iterative image capture process that integrates with the block chain scheme of this embodiment is illustrated in FIG. 11 in process steps [900000] through [960000].

At [160000] within the host server game engine, player [100000] account is connected to a plurality of at least one different player account that has independently entered the game engine via a separate unique account in an otherwise identical process shown in [100000] through [140000]. At the host server [160000], software algorithms initiate a first unique user block chain for a first-time user. Concurrently or alternately the host server can recompile user data into a system block chain for internal or external applications. If a unique user is a repeat user, the unique user's registration recompiles the existing block chain unit.

At [180000] player [100000] debits or credits an online capital account whose proceeds in part or whole will be deployed into the gameplay phase. At [200000] player [100000] will indicate whether and how much of game winnings will apply to a sharing account. The bid so transmitted by player [100000] to the host game server will be acknowledged and accepted by participating community members in concurrent communication with player [100000]. At [220000] the game engine resolves the winner and allocates the capital to the winner and winner designated charitable accounts. Such winnings also debit the proceeds a pre-determined fee that credits a host server SAAS account as a license fee for use of the game. At [240000] the remaining capital distributes to the player member online account and at [260000] the player may further share/donate/purchase/deposit such proceeds in accordance with the host game functions and services.

Therefore, gaming system of the present invention provides a concurrent block chain platform resulting from connections players for an effective game sharing experience across dramatically different gaming platforms and concurrently populates a plurality of block chain elements for which FIG. 7 is a preferred embodiment.

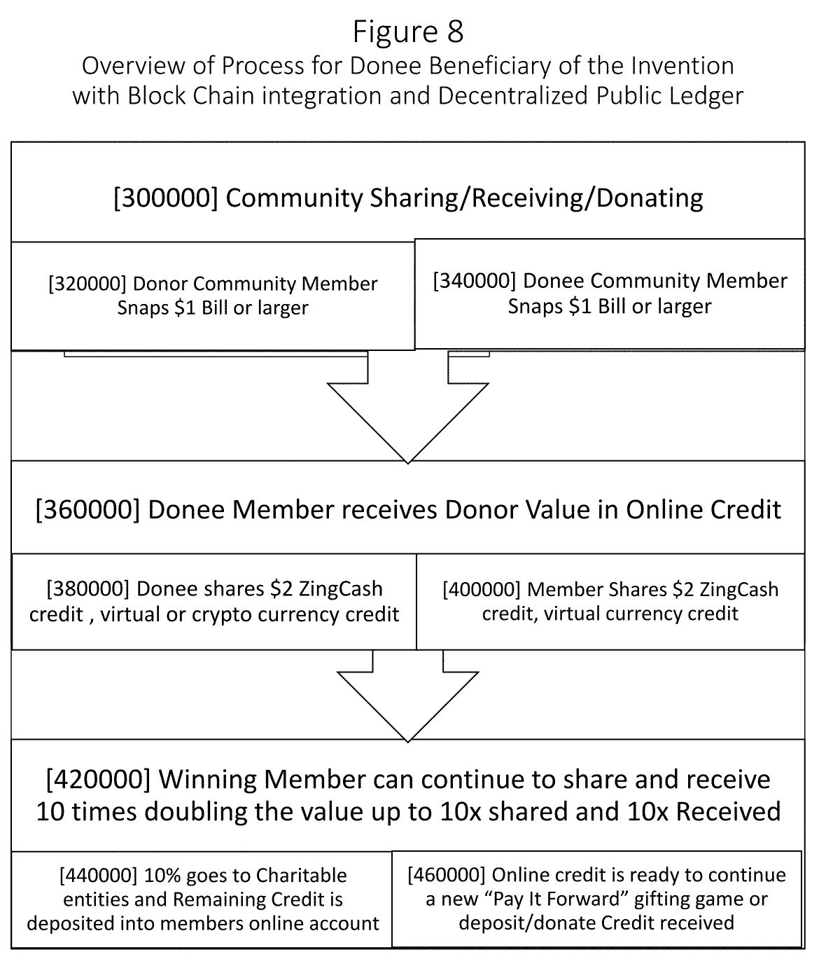

Referring now to FIG. 8, a preferred overview embodiment illustrates how a donee beneficiary realizes such donee proceeds and sequentially creates or recompiles one or more done block chain elements. At [300000] the donative function commences based upon gameplay by co-participating members of the online game community. At [320000] the donor community member provides the unique serial code that is applied in the gameplay as described in FIG. 7. The donor member is deemed to be the community member whose account is debited to the credit benefit of the donee community member shown at [340000]. At steps [360000] to [400000] the game host server performs the online computer processes to allocate the digital funds from and among the respective online accounts. Such transactions may also recompile individual donee blockchain elements or host aggregative block chain elements. At [420000] through [460000] a winning community member (as donee) can iterate the gameplay and if such winning continues can accumulate successive done proceeds for account allocation as communicated in real time by the successful done. Such iterative play can constitute a recompilation of user/done block chains or a host block chain for other internal or external applications.

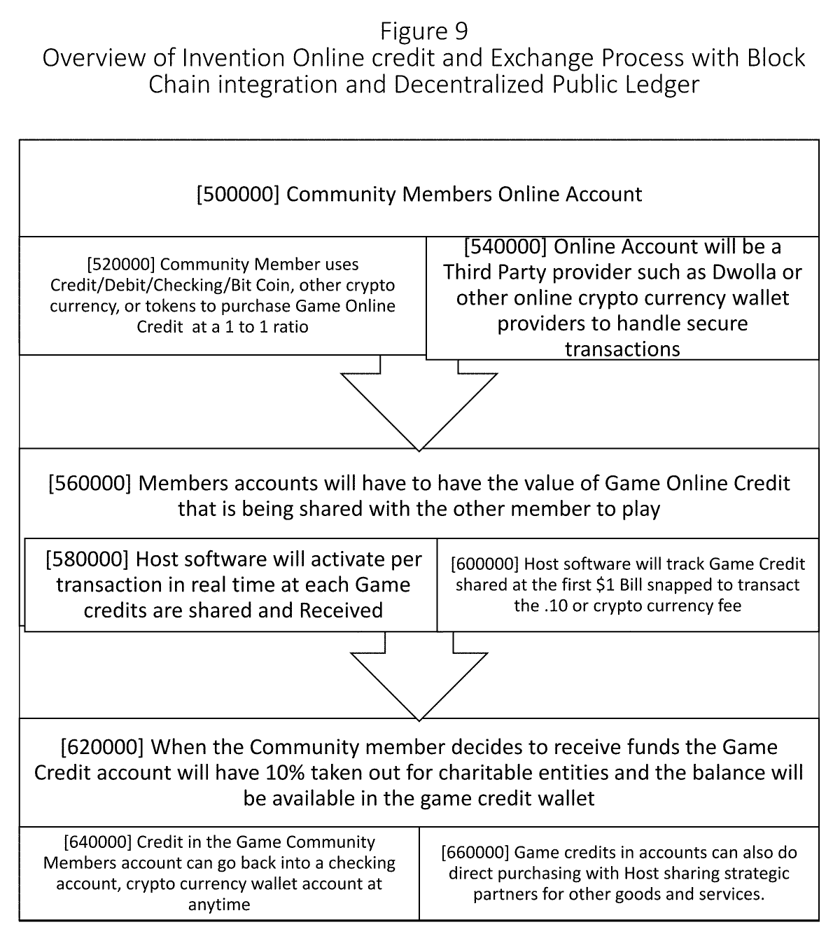

FIG. 9 figure depicts an overview of the invention's online credit and exchange process where real value objects are exchanged and or virtual digital objects of value are created and initialized. At [500000] of FIG. 9, the description of the community member's online account is disclosed. At [520000] community members identify a non-game source of capital from conventional credit cards, banking or debit cards, or non-conventional capital such as Bit coin from which to source game credits typically on a 1:1 unit exchange rate ratio. In the preferred embodiment at [540000] the maintenance of the plurality of online accounts will be through a third-party provider such as Dwolla to handle secure transactions.

Referring further to FIG. 9, at [560000] a queuing system will verify that all community members at time of gameplay have accounts sufficiently funded to cover all game obligations. Such queuing is blockchain terminal event or enabling event as to particular community members at the real time moment of play. At [580000] Host software will activate per transaction in real time at each Game credits are shared and Received. At [600000], Host software will track Game Credit shared at the first $1 Bill snapped to transact the 0.10 fee for the SAAS fee of the Host provider.

At [620000], where the gaming application has an expressed charitable service, then when the Community member decides to receive funds, the Game Credit account will have a sum certain, such as 10% taken out for charitable entities and the balance will be available in the Game credit Wallet. In a preferred embodiment at [640000], Credit in the Game Community Members account can go back into a checking account at any time. In a further preferred embodiment at [660000], Game credits in accounts can also do direct purchasing with Host sharing strategic partners for other goods and services. Such splitting or diversion of value is recompiled into the respective blockchain to the extent the blockchain is an aggregator of disburser of value carried as a virtual digital object of value.

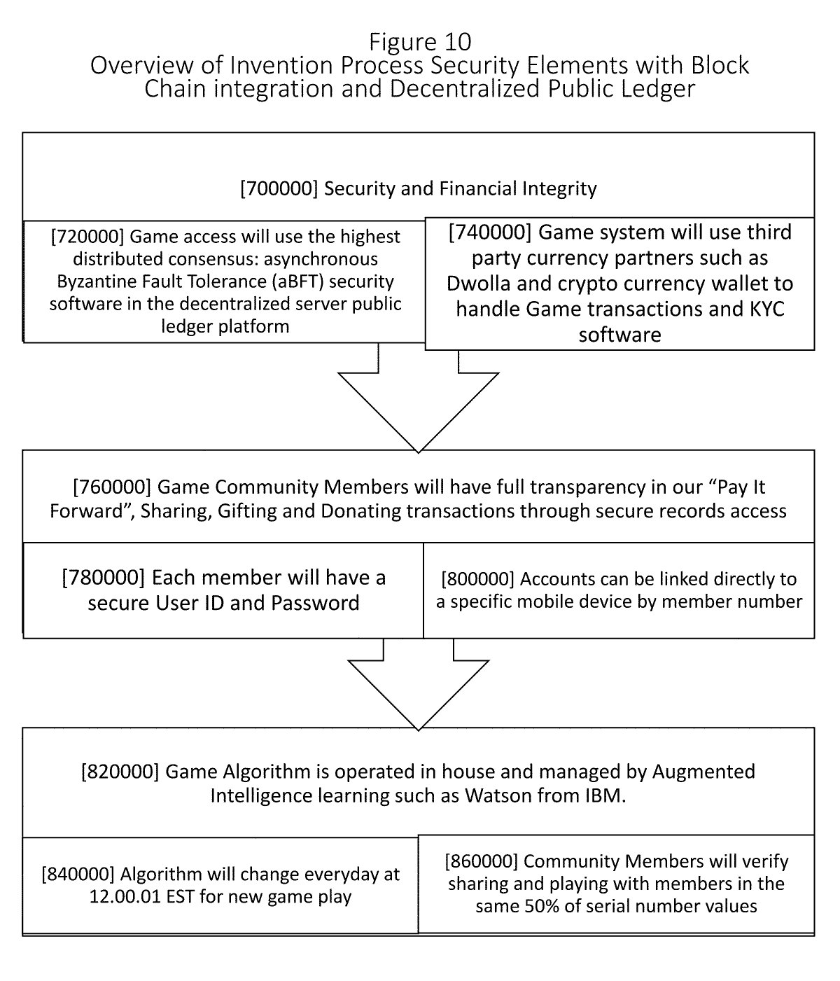

Referring now to FIG. 10 the overview of the invention security and financial elements is shown. At [700000] the security involves independent elements to protect, respectively the integrity of the security of the host server platform [720000] and the financial transaction partners [740000]. As part of the security apparatus the host and individual blockchains can validate and store secure digital objects of value. More specifically, at [740000] Game Community Members will have full transparency in the “Pay It Forward”, Sharing, Gifting and Donating transactions through secure records using dedicated servers and Blockchain, De-Centralized platforms such as Hedera Hashgraph. For the highest security possible. Each community member will have unique and secure User ID and Password protections. Further, at [800000] such secure links can be directly and exclusively linked to specific devices to avoid hacking or re-directed unauthorized entry attempts. In a preferred embodiment, further security can be realized through game algorithms changed frequently [840000] and augmented by third party AI systems [820000]. Finally, [860000] Community Members will verify sharing and playing with members in the same 50% of serial number values at a pre-determined amount with respect to those players.

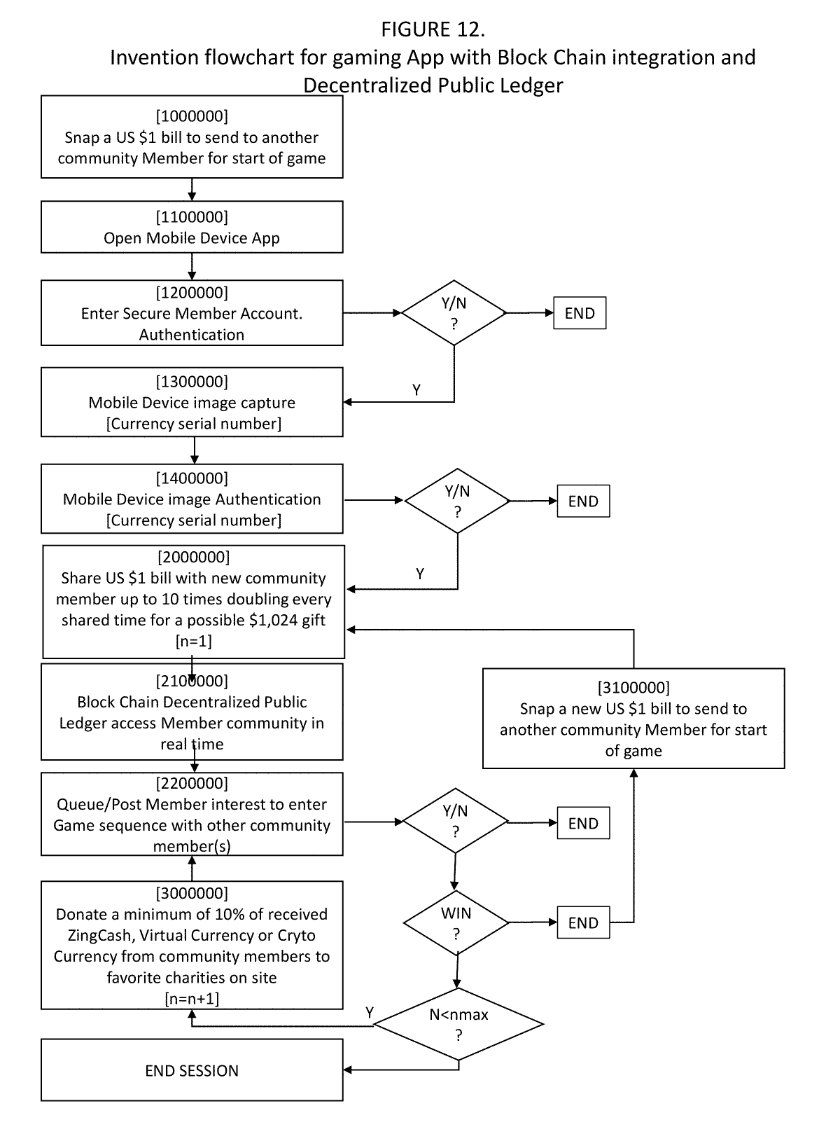

Referring now to FIG. 12, a comprehensive flowchart illustrates a preferred embodiment of the invention components in sequence that illustrates the function, software and decision tree elements used in sequence from a player mobile device and communicated to and from one or more host servers in communication with other users in real time that also comprise a plurality of block chain elements of the invention. At [1000000] the user snaps a US $1 bill to send to another community Member for start of game. The purpose is to capture a specific serial number. At [1100000] the user opens the Mobile Device App. Next, at [1200000] Enter Secure Member Account Authentication. A first decision tree verifies with an authentication algorithm. If unverified, the session terminates. If verified at [1300000] the Mobile Device image capture comprising the Currency serial number, is entered into the game app for secure transmission to the remote host servers. At [1400000] the Mobile Device Image Authentication [Currency serial number] is verified by the host servers to as valid within the game guidelines and not counterfeit or duplicate. A second decision tree verifies with a second authentication algorithm. If unverified, the session terminates. At [2000000] the host queues a Share US $1 bill with new community member up to 10 times doubling every shared time for a possible $1,024 gift [n=1]. It also sets a count of the session iterations to terminate play at a specified count (nmax). At [2100000] Cloud access another Member of the community in real time to play with initial member. This is accomplished at [2200000]. If no member responds in a timely fashion, the session terminates at a third decision tree algorithm. A fourth decision tree determines the game outcome after converting the participant players serial number into ranking through the game algorithm. The winner of the game then proceeds to a count verification to determine if game play can be continued on an available iteration count. At [3000000] the winner donate a minimum of 10% of received ZingCash from community members to favorite charities on site and the game count is set to (n=n+1). At [3100000] a member may Snap a new US $1 bill to send to another community Member for start of a new game at [2000000]. Thereafter the session ends.

Other features of the block chain elements of the invention intended to prevent security breaches, particularly desirable in situations such as high stakes tournament play, are also included in the game application. As applied to DollarZing, prevention of cheating by collaboration of players to maximize the odds of winning is accomplished through random session assignment at certain levels of play. As illustrated by an example shown in FIG. 11, the conversion of physical serial codes cycles through an iterative cycle but limited by cycle to the selected serial codes of the participating members at [900000] through [940000]. Additional features of the block chain elements application are available and understood by example in relation to the DollarZing game application by one skilled in the art.

For those skilled in the art, it will be understood that the invention block chain elements disclosed in FIGS. 7-12 are portable to activities that emulate other risk-based game models. For example, a risk insurer can digitalize its premiums in a scheme that models event occurrence or non-occurrence in real time that is similar to a desired insurable risk transaction. Further, discrete elements of the respective blockchains can employ emergent technologies, particularly quantum computing devices that can carry simultaneous distributed quantum suspended time states alternatives until a real time occurrence requests a real time output. When combined with initial and desired final parameters, such enhanced blockchain scheme can adjust portfolio value holdings to maximize desired outcomes continuously.

It is be understood that changes in the details, materials, steps, and arrangements of parts which have been described and illustrated to explain the nature of the invention will occur to and may be made by those skilled in the art upon a reading of this disclosure within the principles and scope of the invention. Further, terms such as right/left, forward/rearward, and the like, are used for reference only. The foregoing description illustrates the preferred embodiments of the invention; however, concepts, as based upon the description, may be employed in other embodiments without departing from the scope of the invention.

We claim:

1. An electronic multiple player gaming method comprising;
A computer server device specification;
A game operating method to install on said computer server device computer code for use by remote players operating diverse electronic devices in communication with said server;
A method to permit simultaneous game play among said remote players on said diverse devices;
A method requiring said remote player to register in an electronic register upon said server which registration can be identified to advertiser electronic data and specific to said gaming method;
A method for downloading and transmission process of certain computer code from said server to said remote player's electronic device to enable game play on.

2. The method of claim 1 where multiple electronic game systems and multiple users are operated on a common server.

3. The method of claim 1 where one or more remote game players play against a server based computer generated player.

4. The method of claim 1 where computerized elements of the gaming system are housed on multiple servers in electronic communication with each other.

5. The method of claim 4 where remote users game devices may store and operate said computerized elements.

6. The method of claim 1 where the outcomes of said games among one or more remote players are electronically stored and used to access entry into subsequent gaming activities by said remote players.

7. The method of claim 1 where said computer code and said electronic records and activities are encrypted.

8. An electronic accounts management method for a server based electronic multiple player gaming method comprising;
Assigning a unique computer code to each unique electronic account element of said electronic accounts management method;
Providing debit and credit entry components of said player electronic register to provide for payment into and disbursement from of an identifiable fungible value by the game play of a remote electronic game player;
Periodically obtaining payment or receipt of said fungible value from said player;
Implementing an electronic register method for one or more game players to deposit credits or other fungible assets to their respective electronic account;
Providing debit and credit entry components of said remote game player's electronic register to provide for payment into or disbursement from of an identifiable fungible value based on demand for game play of a remote electronic game player and the results of said game play;
Periodically obtaining payment or receipt of said fungible value from said remote game player on a recorded and computed use and transmitted record of said game play;
Electronically connecting said electronic accounts management method to the electronic records of a general accounting ledger method of the operator of said electronic multiple player gaming method.

9. The process of claim 8 where multiple electronic game systems and multiple users are maintained by a single electronic accounts management method.

10. The method of claim 8 where computerized elements of said electronic accounts management method are housed on multiple servers in communication with each other.

11. The method of claim 8 where remote users' game devices may electronically store and operate portions of said electronic accounts management method.
